(19) United States
(12) Patent Application Publication
(10) Pub. No.: US 2021/0334983 A1
(43) Pub. Date: Oct. 28, 2021

(54) IMAGE MONITORING APPARATUS AND METHOD

(71) Applicant: Industrial Technology Research Institute, Hsinchu (TW)

(72) Inventors: Hian-Kun Tenn, Tainan City (TW); Jay Huang, Tainan City (TW); Chia-Chang Li, Pingtung County (TW)

(73) Assignee: Industrial Technology Research Institute, Hsinchu (TW)

(21) Appl. No.: 16/858,718

(22) Filed: Apr. 27, 2020

(51) Int. Cl. G06T 7/20; G08B 21/04; G06K 9/00

(52) U.S. Cl. CPC G06T 7/20; G08B 21/0476; G06T 2207/30196; G08B 21/043; G08B 21/0423; G06K 9/00771

(57) ABSTRACT

An image monitoring apparatus including an image sensing module and a processor is provided. The image sensing module is configured to obtain an invisible light dynamic image of an objective scene. The invisible light dynamic image includes a plurality of frames. The processor is configured to perform operations according to at least one frame of the invisible light dynamic image to determine a status of at least one live body corresponding to the objective scene to be one of a plurality of status types and determine at least one status valid region of the invisible light dynamic image, and set scene information of each pixel of the at least one status valid region to be one of a plurality of scene types according to the status type of the at least one live body. An image monitoring method is also provided.

### TECHNICAL FIELD

The disclosure relates to an image monitoring apparatus and an image monitoring method.

### BACKGROUND

As the average life expectancy for human beings extended with the advancement of medical technology, there are now increasing health care demands for elders. Further, for elders at home, the number of elders living alone accounts for a certain proportion, while the institutional and community care personnel are limited. Therefore, technology assistance is used throughout the world to develop home care services.

The accidental injuries of elders are mainly caused by off-bed behavior in bedroom, harmful and abnormal movements, slippery floors and the like. Accordingly, preventions and immediate treatments become important requirements for health care at home. For example, an elder might get up from bed at night and fell, but were not discovered until the next morning. Another example is that an elder might feel unwell in bed and unable to seek help from the outside. Therefore, immediate notification of those abnormal movements is an urgent need.

Existing care systems mostly use wearable sensing devices or pressure pads. However, the sensor needs to be worn for a long time, and elders may have a low willingness to wear or even remove it by themselves. In addition, abnormal falls cannot be sensed at any time due to the limited range for disposing the pressure pads. On the other hand, although the current artificial intelligence (AI) recognition technology has a high accuracy in motion recognition, the recognition is still done by using common images. Here, the common images refer to images that will show privacy features such as facial feature, clothing or body surface of the user. Consequently, a care receiver will feel that the privacy has been violated and thus has low willingness to install it.

### SUMMARY

An embodiment of the disclosure proposes an image monitoring apparatus, which includes an image sensing module and a processor. The image sensing module is configured to obtain an invisible light dynamic image of an objective scene. The invisible light dynamic image includes a plurality of frames. The processor is configured to: perform operations according to at least one frame of the invisible light dynamic image to determine a status of at least one live body corresponding to the objective scene to be one of a plurality of status types and determine at least one status valid region of the invisible light dynamic image, and set scene information of each pixel of the at least one status valid region to be one of a plurality of scene types according to the status type of the at least one live body.

An embodiment of the disclosure proposes an image monitoring method, which includes: obtaining an invisible light dynamic image of an objective scene; performing operations according to at least one frame of the invisible light dynamic image to determine a status of at least one live body corresponding to the objective scene to be one of a plurality of status types and determine at least one status valid region of the invisible light dynamic image, and setting scene information of each pixel of the at least one status valid region to be one of a plurality of scene types according to the status type of the at least one live body.

### BRIEF DESCRIPTION OF THE DRAWINGS

FIG. 1 is a schematic diagram of an image monitoring apparatus in an embodiment of the disclosure.

FIG. 2 shows an invisible light dynamic image obtained by the image monitoring apparatus of FIG. 1.

FIG. 3A, FIG. 3B and FIG. 3C are distribution diagrams of monitoring scene information of pixels corresponding to an objective scene in three different times in sequence.

FIG. 4A, FIG. 4B and FIG. 4C are probability distributions of scene types of the pixels in an area P1 of FIG. 3A, FIG. 3B and FIG. 3C.

FIG. 5 is a schematic diagram of an invisible light dynamic image obtained by an image monitoring apparatus in another embodiment of the disclosure.

FIG. 6 is a flowchart of an image monitoring method in an embodiment of the disclosure.

FIG. 7 is a flowchart of detailed steps of steps S220 and S230 in FIG. 6.

FIG. 8A is a schematic diagram for shrinking a live body framed region in steps S110 to S114 of FIG. 7.

FIG. 8B is a schematic diagram for setting a scene type of an area with a height of 50 pixels below the live body framed region to floor in step S120 of FIG. 7.

### DETAILED DESCRIPTION

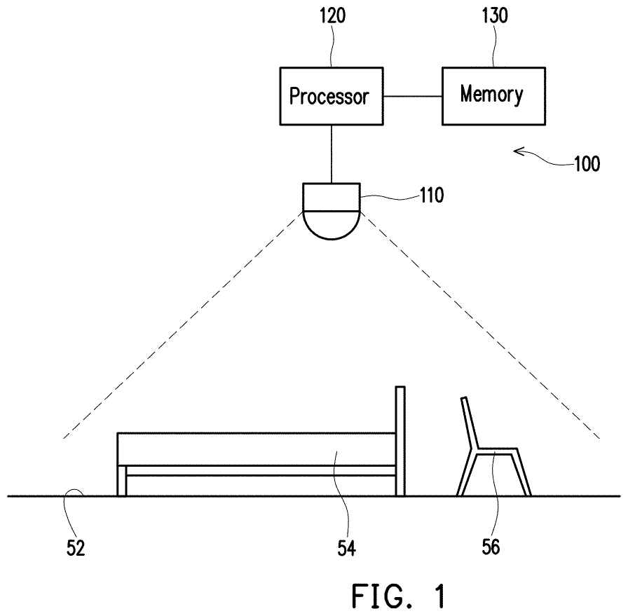

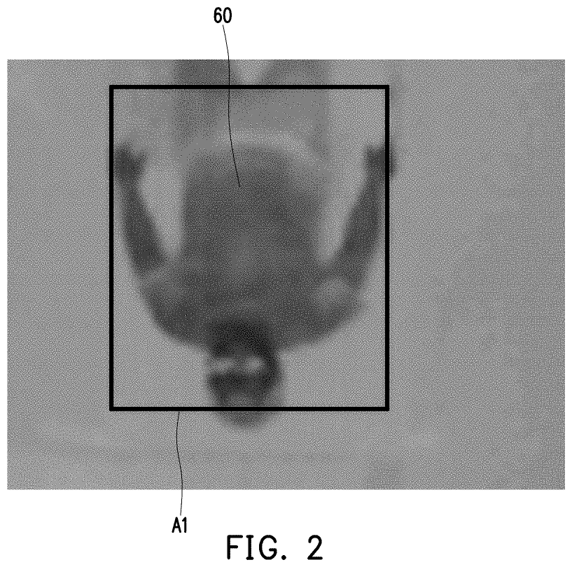

FIG. 1 is a schematic diagram of an image monitoring apparatus in an embodiment of the disclosure, and FIG. 2 shows an invisible light dynamic image obtained by the image monitoring apparatus of FIG. 1. Referring to FIG. 1 and FIG. 2, an image monitoring apparatus 100 of this embodiment includes an image sensing module 110 and a processor 120. The image sensing module 110 is configured to obtain an invisible light dynamic image of an objective scene. The invisible light dynamic image includes a plurality of frames (FIG. 2 shows one of the frames). In other words, the invisible light dynamic image is composed of the plurality of frames respectively sensed and imaged at different time points. In this embodiment, the invisible light dynamic image may be a thermal image, and the image sensing module 110 may be a thermal image camera for detecting the thermal image. Nonetheless, in other embodiments, the invisible light dynamic image may also be a radio frequency echo image or an ultrasound image, and the image sensing module 110 may be an ultrasound transceiver or a radio frequency electromagnetic wave transceiver.

The processor 120 is configured to perform the following steps. First of all, the processor 120 performs operations according to at least one frame of the invisible light dynamic image (e.g., the frame shown by FIG. 2) to determine a status of at least one live body 60 corresponding to the objective scene to be one of a plurality of status types and determine at least one status valid region A1 of the invisible light dynamic image, and then sets scene information of each pixel of the at least one status valid region A1 to one of a plurality of scene types according to the status type of the at least one live body 60. For instance, the at least one live body 60 is a human body, and the status types include at least one of standing, sitting, lying, crawling and undefined. Here, the status type of the live body 60 shown by FIG. 2 is, for example, lying. In addition, for example, the scene types include at least one of floor 52, bed 54, chair 56 and an undefined type.

In the embodiment shown by FIG. 1 and FIG. 2, when the processor 120 determines the status type of the at least one live body 60 to be standing, the processor 120 sets the scene information of each pixel of the at least one status valid region A1 to floor. When the processor 120 determines the status type of the at least one live body 60 to be sitting, the processor 120 sets the scene information of each pixel of the at least one status valid region A1 to chair. When the processor 120 determines the status type of the at least one live body 60 to be lying, the processor 120 sets the scene information of each pixel of the at least one status valid region A1 to bed. Taking the live body 60 shown by FIG. 2 as an example, because the processor 120 determines that the status type is lying and the corresponding scene type is bed, the processor 120 further sets the scene information of each pixel in the status valid region A1 to bed.

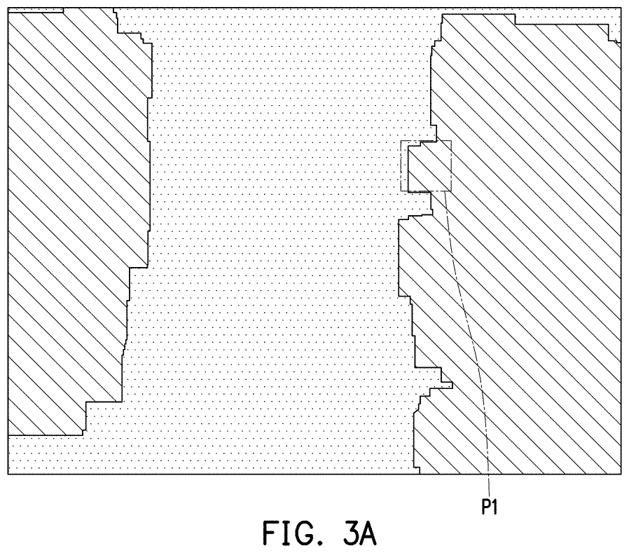

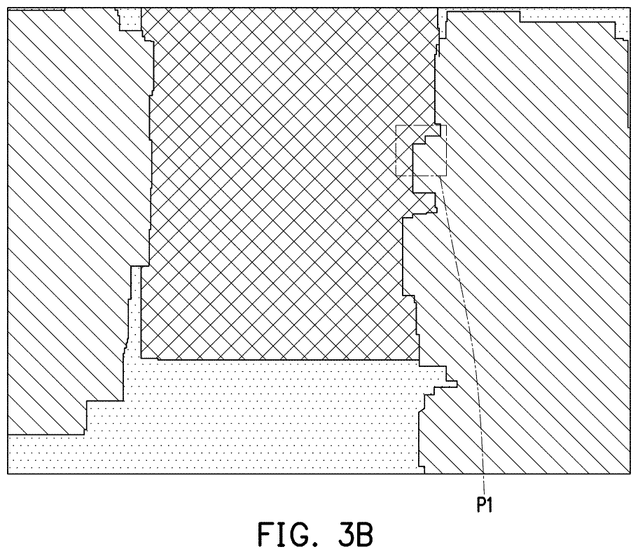

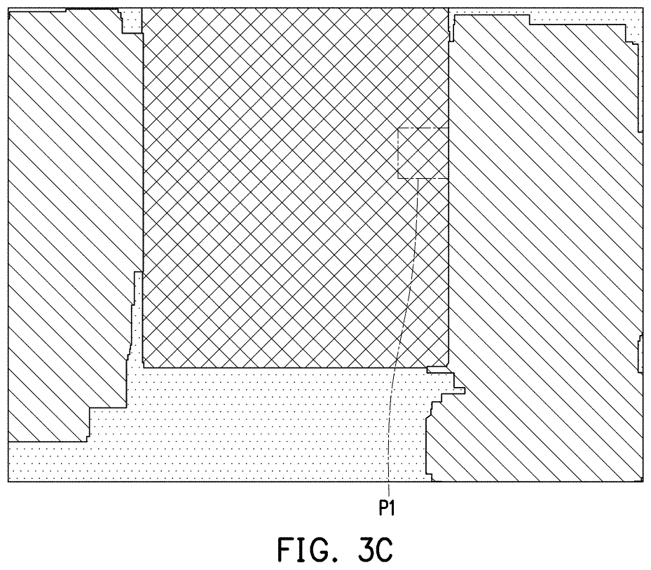

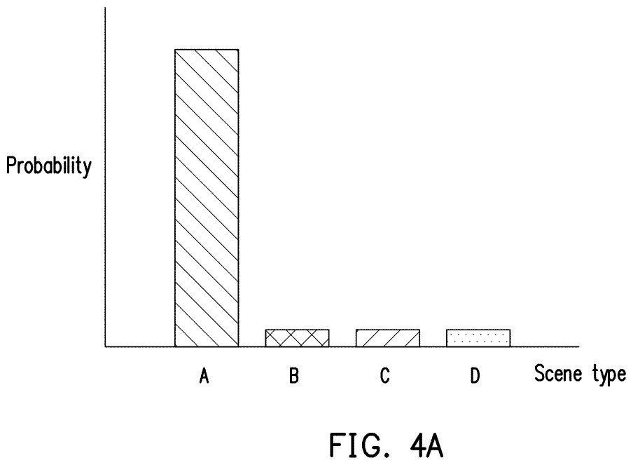

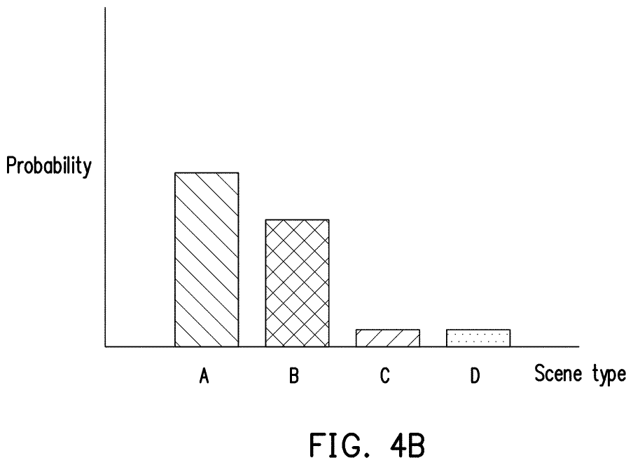

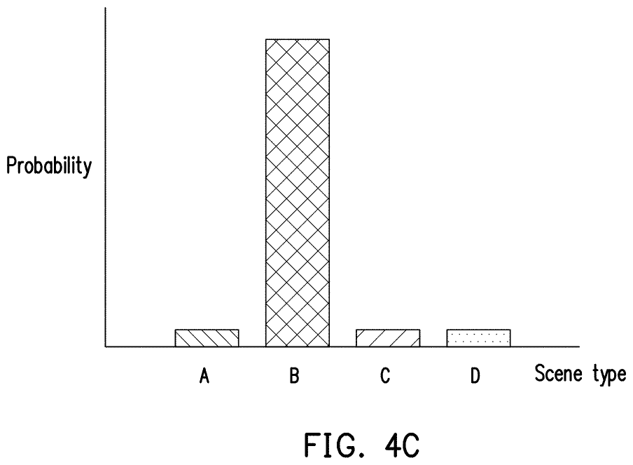

FIG. 3A, FIG. 3B and FIG. 3C are distribution diagrams of monitoring scene information of pixels corresponding to an objective scene in three different times in sequence, and FIG. 4A, FIG. 4B and FIG. 4C are probability distributions of scene types of the pixels in an area P1 of FIG. 3A, FIG. 3B and FIG. 3C. Referring to FIG. 3A and FIG. 4A, in this embodiment, each pixel in the invisible light dynamic image has a probability distribution of the scene types (as shown by FIG. 4A). The processor 120 is configured to set monitoring scene information of each pixel to the scene type having a highest probability in the probability distribution of the scene types of the pixel. In this embodiment, the scene types of each pixel having the probability distribution of the scene types include floor (e.g., a scene type A in FIG. 4A), bed (e.g., a scene type B), chair (e.g., a scene type C) and the undefined type (e.g., a scene type D). Further, in this embodiment, the processor 120 is configured to update the probability distribution of the scene types of each pixel in the status valid region A1 according to the least one status valid region A1 of the at least one frame and the scene information of each pixel of the at least one status valid region A1.

For instance, after installation of the image monitoring apparatus 100 is completed, the monitoring scene information of all pixels of the invisible light dynamic image is preset to the scene type D (i.e., the undefined type) for the entire scene at the beginning, and the scene type D is a default type of the pixels. At the time, an installation personnel may walk on the floor 52. Meanwhile, the processor 120 performs operations and determinations according to the frames to determine the status type of the live body 60 (i.e., the installation personnel) in each frame to be standing and determine the corresponding status valid region, and updates the probability distribution of the scene types of the pixels of the status valid region (e.g., the left and right sides of FIG. 3A) corresponding to the live body 60 in each frame according to the status type of the live body 60 in each frame. In this embodiment, because the status type is standing that corresponds to the scene type A (i.e., floor 52), in the probability distribution of the scene types of the pixels in the status valid region (e.g., the left and right sides of FIG. 3A), a probability of the scene type A (i.e., floor 52) increases and exceeds probabilities of the scene type B, the scene type C and the scene type D. Therefore, the processor 120 sets the monitoring scene information of the pixels in the status valid region (e.g., the left and right sides of FIG. 3A) to the scene type A (as shown by FIG. 3A). In addition, an area on which the installation personnel does not walk or stand on (e.g., the center of the objective scene) will be described as follows. Referring to FIG. 3A, because information of the scene types is not added and accumulated for the area on which the installation personnel does not walk or stand on (the area near the center), the probability distribution of the scene types will not be updated and changed. Therefore, the monitoring scene information maintains at the default scene, i.e., the scene type D.

Then, the installation personnel may lie down in a central area of the objective scene and maintained the status of lying for a period of time. Meanwhile, the processor 120 performs operations and determinations according to the frames during that period of time to determine the status type of the live body 60 (i.e., the installation personnel) in each frame to be lying and determine the corresponding status valid region, and updates the probability distribution of the scene types of the pixels of the status valid region (e.g., the area near the center in the objective scene) corresponding to the live body 60 in each frame according to the status type of the live body 60 in each frame. In this embodiment, because the status type is lying that corresponds to the scene type B (i.e., the type corresponding to bed), in the probability distribution of the scene types of the pixels in the status valid region (e.g., the area near the center in the objective scene), the probability of the scene type B (i.e., the type corresponding to bed) increases. Once the probability of the scene type B becomes a highest probability in the probability distribution of the scene types, the processor 120 sets the monitoring scene information of the pixels in the status valid region (e.g., the area near the center in the objective scene) to the scene type B.

However, at boundaries of the left and right areas (such as the area P1) of the status valid region (e.g., the area near the center in the objective scene), none is clearly higher in the probability distribution of the scene types. In a case where the probability of the scene type A is close to the probability of the scene type B in the probability distribution of the scene types for the pixels in the area P1, the processor 120 is unable to determine the scene type for the area P1. In this case, the installation personnel may continue to lie down or move his/her body to change or expand the lying position, so that the frames may be continuously accumulated for the processor 120 to perform operations and determinations. After a certain period of time, as shown by FIG. 3C and FIG. 4C, the probability of the scene type B in the probability distribution of the scene types of the pixels in the area P1 becomes the highest one among all the scene types. In this case, the processor 120 determines the monitoring scene information of all the pixels in the area P1 to be the scene type B (i.e., the type corresponding to bed 54). So far, although the invisible light dynamic image (e.g., the thermal image) does not contain sensitive and detailed information such as human face, clothing, body surface and indoor furnishing, the processor 120 can still determine a range in which bed 54 is located to be a range in which the scene type B in FIG. 3C is located, and accordingly determine whether there is any abnormality.

In this embodiment, the image monitoring apparatus 100 further includes a memory 130 electrically connected to the processor 120. Here, the processor 120 is configured to store the invisible light dynamic image and the scene type each pixel in the memory 130. For instance, the processor 120 may store data of the probability distribution of the scene types shown by FIG. 3C in the memory 130 or store the monitoring scene information of each pixel of the invisible light dynamic image in the memory 130 as a basis for determining whether there is any abnormal activity. The memory 130 is, for example, a hard disk, a flash memory, a random access memory or other suitable memories. In the foregoing embodiment, the monitoring scene information of each pixel of the invisible light dynamic image of the objective scene is constructed according to activities of the installation personnel. However, in other embodiments, the monitoring scene information may also be constructed according to activities of a care receiver or other personnel.

Here, in this embodiment, the processor 120 is configured to perform operations according to another frame of the invisible light dynamic image to determine a status of a monitoring live body (e.g., the care receiver) in the objective scene to be one of the status types and determine at least one detection valid region corresponding to the monitoring live body, determine whether the status of the monitoring live body is abnormal according to the at least one detection valid region corresponding to the monitoring live body, the status of the monitoring live body and the monitoring scene information or the scene information of the at least one detection valid region corresponding to the monitoring live body, and output a warning signal when determining that the status of the monitoring live body is abnormal. For example, the warning signal may be transmitted to a computer or a monitoring system of an office in a local area (e.g., in the community) through the local area network, or transmitted to a monitoring host or a computer of a remote monitoring center through the Internet.

For instance, after the processor 120 determines that the status type of the monitoring live body is lying, the pixels of the detection valid region corresponding to the monitoring live body is the scene type A (i.e., floor 52) and the status of the monitoring live body lasts for a preset time (e.g., 30 minutes), the processor 120 may then determine that the monitoring live body has been lying on floor 52 for too long and the abnormality occurs. Accordingly, the processor 120 outputs the warning signal to notify the personnel from a care or medical unit to come and check, or notify the personnel from a remote monitoring center to notify others to come and check. Alternatively, after the processor 120 determine that the status type of the monitoring live body (i.e., the care receiver) is lying, the pixels of the detection valid region corresponding to the monitoring live body is the scene type B (i.e., bed 54) and the status of the monitoring live body lasts for over another preset time (e.g., over 12 hours), the processor 120 may determine the status of the monitoring live body is abnormal (e.g., unable to get up due to poor physical condition) and output the warning signal.

Operations for determining the detection valid region in this embodiment are identical to operations for determining the status valid region in the foregoing embodiment. Nevertheless, the detection valid region is determined according to the status of the monitoring live body (e.g., the care receiver) in this embodiment, whereas the status valid region is determined according to the status of the live body (e.g., the installation personnel) in the foregoing embodiment.

In one embodiment, the processor 120 is, for example, a central processing unit (CPU), a microprocessor, a digital signal processor (DSP), a programmable controller, a programmable logic device (PLD) or other similar devices or a combination of these devices, which are not particularly limited by the disclosure. Further, in an embodiment, various functions of the processor 120 may be implemented as a plurality of program codes. These program codes will be stored in the memory so the program codes executed by the processor 120 later. Alternatively, in an embodiment, various functions of the processor 120 may be implemented as one or more circuits. The disclosure is not intended to limit whether various functions of the processor 120 are implemented by ways of software or hardware.

Further, in another embodiment, as illustrated by FIG. 5, the number of live bodies in the objective scene may be multiple, and the number of corresponding status valid regions may also be multiple. In this embodiment, the number of live bodies is two (e.g., a first live body 61 and a second live body 62 in FIG. 5), for example. In order to clearly distinguish and explain, the first live body 61 and a first status valid region B1 corresponding thereto are used in the following description together with the second live body 62 and a second status valid region B2 corresponding thereto. The processor 120 is configured to perform the following steps. First of all, the processor 120 performs operations according to at least one frame of the invisible light dynamic image to determine a status of the first live body 61 in the objective scene to be one of a plurality of status types and a status of the second live body 62 to be one of the status types, and determine at least one first status valid region B1 of the invisible light dynamic image corresponding to the status of the first live body 61 and at least one second status valid region B2 of the invisible light dynamic image corresponding to the status of the second live body 62. Next, scene information of each pixel of the first status valid region B1 is set to one of a plurality of scene types according to the status type of the first live body 61, and scene information of each pixel of the second status valid region B2 is set to one of the scene types according to the status type of the second live body 62. For example, the processor 120 calculates and determines that the status type of the first live body 61 is lying, and determines the first status valid region B1 corresponding thereto. Meanwhile, the processor 120 determines that the status type of the second live body 62 is standing, and determines the second status valid region B2 corresponding thereto. Next, the processor 120 updates a probability distribution of the scene types of the pixels of the first status valid region B1 according to the status type of the first live body 61, and updates a probability distribution of the scene types of the pixels of the second status valid region B2 according to the status type of the second live body 62. In this embodiment, in the probability distribution of the scene types of the pixels of the first status valid region B1, a probability of the scene type B (i.e., the type corresponding to bed) corresponding to status of lying increases; and in the probability distribution of the scene types of the pixels of the second status valid region B2, a probability of the scene type A (i.e., floor) corresponding to the status of standing increases. The processor 120 determines the monitoring scene information of each pixel of the invisible light dynamic image according to the probability distribution of the scene types of each pixel.

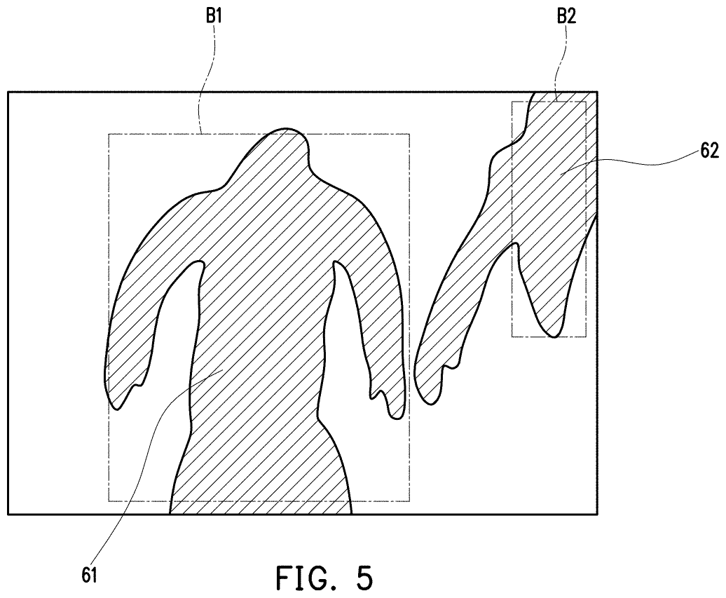

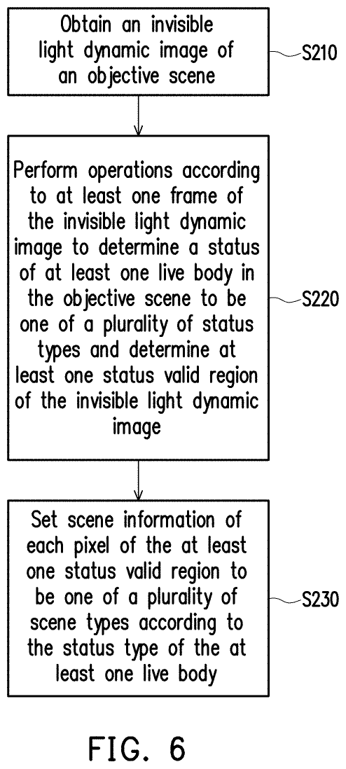

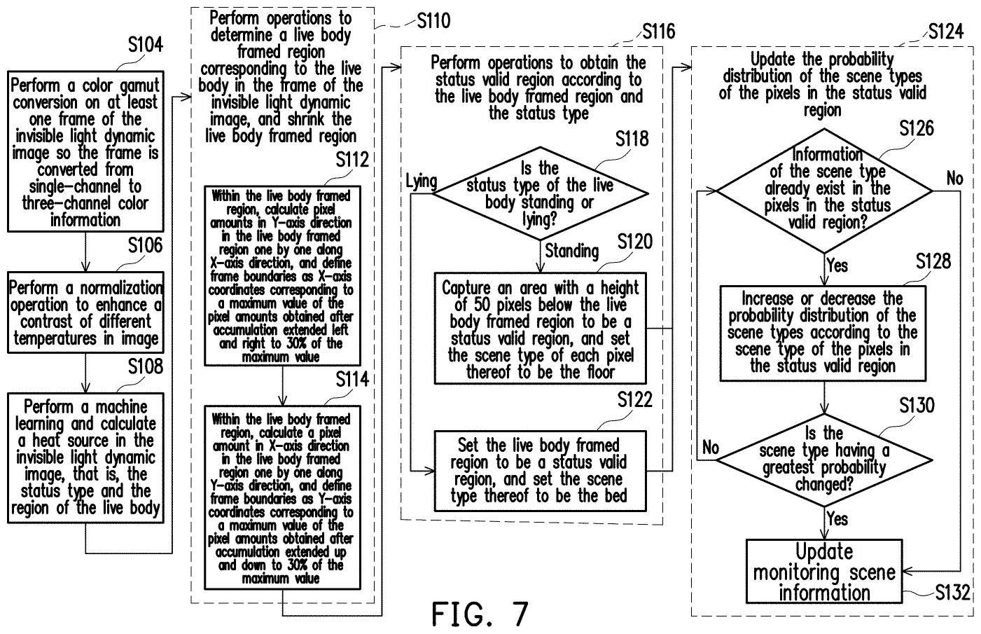

FIG. 6 is a flowchart of an image monitoring method in an embodiment of the disclosure. Referring to FIG. 1, FIG. 2 and FIG. 6, the image monitoring method of this embodiment may be implemented by the image monitoring apparatus 100 described above. The image monitoring method includes the following steps. First of all, step S210 is executed to obtain an invisible light dynamic image of an objective scene. Next, step S220 is executed to perform operations according to at least one frame of the invisible light dynamic image to determine a status of at least one live body 60 in the objective scene to be one of a plurality of status types and determine at least one status valid region A1 of the invisible light dynamic image. Then, step S230 is executed to set scene information of each pixel of the at least one status valid region A1 to be one of a plurality of scene types according to the status type of the at least one live body 60. For details of the image monitoring method, reference may be made to the operations executed by the image monitoring apparatus 100 described above, which will not be repeated here. In the following, the operations executed by the image monitoring apparatus 100 and the steps of the image monitoring method of this embodiment will be described in more detail, as shown by FIG. 7.

Referring to FIG. 7, detailed steps of steps S220 and S230 are described as follows. In this embodiment, the invisible light dynamic image is thermal image data. After the invisible light dynamic image is obtained, the processor 120 executes step S104 to perform a color gamut conversion on at least one frame of the invisible light dynamic image so the frame (the thermal image data) is converted from single-channel to three-channel color information. The processor 120 executes step S106 to perform a normalization operation on the output from the color gamut conversion in step S104 to enhance a contrast of different temperatures in image. For instance, the normalization operation may be performed according to a highest temperature within a temperature range to highlight the contrast of different temperatures in image within the temperature range. Next, the processor 120 executes step S108 to perform a machine learning according to the result of calculation processed in step S106 and calculate a heat source in the invisible light dynamic image, that is, the status type and the region of the live body. In other words, the live body in the invisible light dynamic image may be determined in this way.

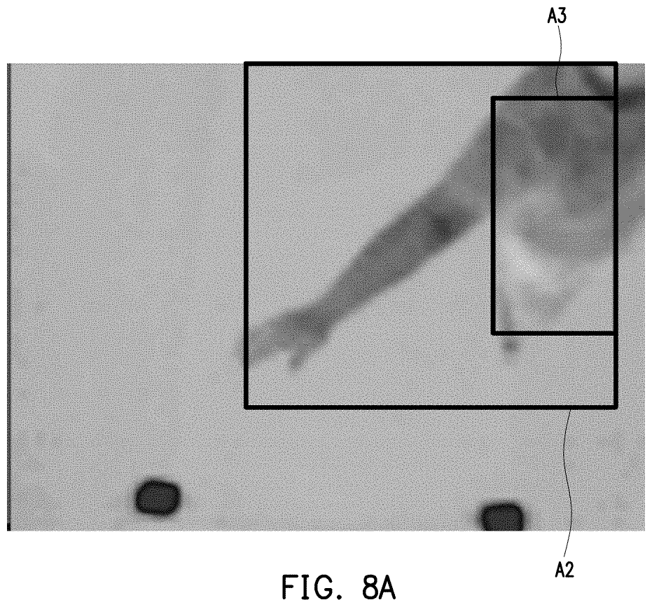

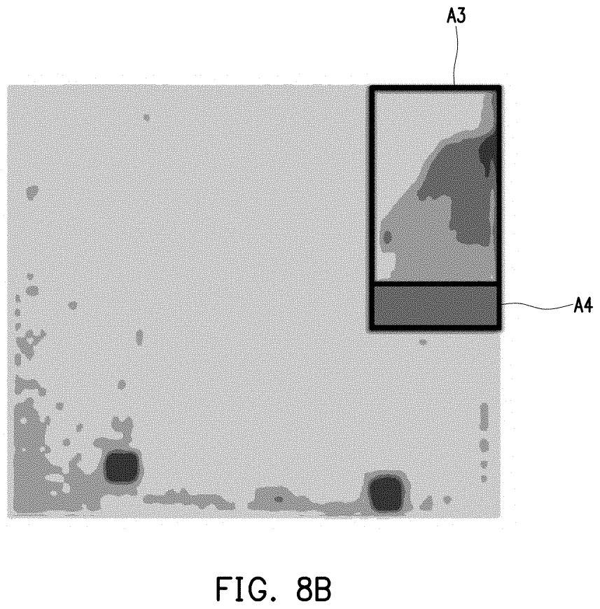

Then, step S110 is executed to perform operations on the frame and information of the invisible light dynamic image obtained from calculation of step S108 to determine a live body framed region corresponding to the live body in the frame of the invisible light dynamic image (e.g., determine a live body framed region A2 corresponding to the live body in the frame of the invisible light dynamic image of FIG. 8A), and perform operations to shrink the live body framed region A2 into a live body framed region A3. In other words, the live body framed region corresponding to the live body is determined and shrunk from including the limbs (the live body framed region A2) to including the body (the live body framed region A3). The details of step S110 further include step S112 and step S114. In step S112, within the live body framed region A2, the processor calculates a pixel amount in Y-axis direction (i.e., a vertical axis direction) in the live body framed region A2 one by one along X-axis direction (i.e., a horizontal axis direction), and define frame boundaries as X-axis coordinates corresponding to a maximum value of the pixel amounts obtained after accumulation extended left and right to 30% of the maximum value. In step S114, within in the live body framed region A2, the processor calculates a pixel amount in X-axis direction (i.e., the horizontal axis direction) in the live body framed region A2 one by one along Y-axis direction (i.e., the vertical axis direction), and define frame boundaries as Y-axis coordinates corresponding to a maximum value of the pixel amounts obtained after accumulation extended up and down to 30% of the maximum value. After step S110 (including steps S112 and S114) is executed, the live body framed region A2 is converged to the live body framed region A3, i.e., a live body range (a region based on the body) is determined.

Then, step S116 is executed so that the processor 120 performs operations to obtain the status valid region according to the live body framed region A3 and the status type. The details of step S116 further include step S118, step S120 and step S122. In step S118, the processor 120 determines whether the status type of the live body is standing or lying (or whether the status type is standing, sitting or lying may also be determined in other embodiments). In the case where the status of the live body is determined to be standing, step S120 is executed to capture an area with a height of 50 pixels below the live body framed region A3 (which is generated after the steps S112 and S114 are executed) to be a status valid region A4, and set the scene type of each pixel of the status valid region A4 to floor 52, as shown by FIG. 8A. However, the disclosure is not limited to a height range of 50 pixels, which may also be the height of other numbers of pixels in other embodiments. In the case where the status of the live body is determined to be lying, step S122 is executed to set the live body framed region (which is generated after the steps S112 and S114 are executed) to be a status valid region A1, and set the scene type thereof to bed 54, as shown by FIG. 2.

After step S120 or step S122 is executed, step S124 is executed to update the probability distribution of the scene types of the pixels in the status valid region. The details of step S124 further include step S126, step S128, step S130 and step S132. In step S126, the processor 120 determines whether information of the scene type already exist in the pixels in the status valid region, i.e., determine whether the types other than the scene type D (i.e., an undefined type) exist. If the information of the scene type already exist, step S128 is executed so that the processor 120 increases or decreases the probability distribution of the scene types according to the scene type of the pixels in the status valid region. Then, step S130 is executed to determine whether the scene type having a greatest probability in the probability distribution of the scene types of each pixel is changed. If the scene type having the greatest probability is changed, step S132 is executed to update the monitoring scene information. For example, the monitoring scene information in the area P1 is updated from the scene type of the pixels in the area P1 of FIG. 3B to the scene type of the pixels in the area P1 of FIG. 3C. If the scene type having the greatest probability is not changed, step S126 is executed again. In step S126, if it is determined that the type definition does not exist, step S132 is executed to update the monitoring scene information.

It should be noted that in the embodiments of the disclosure, the status types include at least one of standing, sitting, lying, crawling, and undefined, which are used as an example for the description. In other embodiments, the status types may be more or less according to monitoring needs or monitoring priorities; in addition, the scene types may also be more or less according to monitoring needs, monitoring priorities or focal points. In certain embodiments, the scene types may also be the same as the status types, that is, the scene information of the pixels is available for standing, walking or lying. In another embodiment, the scene type may also include allowed or forbidden. In other words, the pixels of the region where the live body (e.g., the installation personnel) in the invisible light dynamic image was in may be set to an allowed scene type, and the pixels of the invisible light dynamic image (or a not-updated region) are preset to a forbidden scene type. Such an embodiment is used for anti-theft or security monitoring, so this disclosure is not limited only to health care.

In summary, according to the image monitoring apparatus and method of the embodiment of the disclosure, the image monitoring apparatus is used to recognize the live body, the status type and the status valid region, and set the scene information of each pixel of the status valid region to one of the scene types. As a result, the image monitoring apparatus and method in the embodiments of the disclosure can be used to perform good and effective security monitoring by using a low-sensitivity image of the care receiver, so as to maintain the privacy of the care receiver.

1. An image monitoring apparatus, comprising:
an image sensing module, configured to obtain an invisible light dynamic image of an objective scene, wherein the invisible light dynamic image comprises a plurality of frames; and
a processor, configured to:
perform operations according to at least one frame of the invisible light dynamic image to determine a status of at least one live body in the objective scene to be one of a plurality of status types and determine at least one status valid region of the invisible light dynamic image; and
set scene information of each pixel of the at least one status valid region to one of a plurality of scene types according to the status type of the at least one live body.

2. The image monitoring apparatus of claim 1, wherein the invisible light dynamic image is a thermal image, a radio frequency echo image or an ultrasound image.

3. The image monitoring apparatus of claim 1, wherein the at least one live body is a human body, and the status types comprise at least one of standing, sitting, lying, crawling and undefined.

4. The image monitoring apparatus of claim 3, wherein the processor is further configured to:
set the scene information of each pixel of the at least one status valid region to floor when the status type of the at least one live body is determined to be standing;
set the scene information of each pixel of the at least one status valid region to chair when the status type of the at least one live body is determined to be sitting; and
set the scene information of each pixel of the at least one status valid region to bed when the status type of the at least one live body is determined to be lying.

5. The image monitoring apparatus of claim 1, wherein each pixel in the invisible light dynamic image has a probability distribution of the scene types, and the processor is configured to set monitoring scene information of each pixel to the scene type having a highest probability in the probability distribution of the scene types of the pixel.

6. The image monitoring apparatus of claim 5, wherein the processor is configured to update the probability distribution of the scene types of each pixel in the status valid region according to the least one status valid region of the at least one frame and the scene information of each pixel of the at least one status valid region.

7. The image monitoring apparatus of claim 5, wherein the scene types comprise at least one of floor, bed, chair and an undefined type.

8. The image monitoring apparatus of claim 1, wherein the scene types comprise at least one of floor, bed, chair and an undefined type.

9. The image monitoring apparatus of claim 1, further comprising: a memory electrically connected to the processor, wherein the processor is configured to store the invisible light dynamic image and the scene information corresponding to each pixel in the memory.

10. The image monitoring apparatus of claim 1, wherein the processor is configured to perform operations according to another frame of the invisible light dynamic image to determine a status of a monitoring live body in the objective scene to be one of the status types and determine at least one detection valid region corresponding to the monitoring live body, determine whether the status of the monitoring live body is abnormal according to the at least one detection valid region corresponding to the monitoring live body, the status of the monitoring live body and the scene information of the at least one detection valid region corresponding to the monitoring live body, and output a warning signal when determining that the status of the monitoring live body is abnormal.

11. The image monitoring apparatus of claim 5, wherein the processor is configured to perform operations according to another frame of the invisible light dynamic image to determine a status of a monitoring live body in the objective scene to be one of the status types and determine at least one detection valid region corresponding to the monitoring live body, determine whether the status of the monitoring live body is abnormal according to the at least one detection valid region corresponding to the monitoring live body, the status of the monitoring live body and the monitoring scene information of the at least one detection valid region corresponding to the monitoring live body, and output a warning signal when determining that the status of the monitoring live body is abnormal.

12. The image monitoring apparatus of claim 1, wherein the at least one live body is a plurality of live bodies, the at least one status valid region is a plurality of status valid regions, the live bodies respectively correspond to the status valid regions, and the processor is configured to:
perform operations according to the at least one frame of the invisible light dynamic image to determine each of statuses of the live bodies in the objective scene to be one of the status types and determine the status valid regions of the invisible light dynamic image; and
set the scene information of each pixel of the corresponding status valid region to one of the scene types according to the status type of each of the live bodies.

13. An image monitoring method, comprising:
obtaining an invisible light dynamic image of an objective scene;
performing operations according to at least one frame of the invisible light dynamic image to determine a status of at least one live body in the objective scene to be one of a plurality of status types and determine at least one status valid region of the invisible light dynamic image; and
setting scene information of each pixel of the at least one status valid region to one of a plurality of scene types according to the status type of the at least one live body.

14. The image monitoring method of claim 13, wherein the invisible light dynamic image is a thermal image, a radio frequency echo image or an ultrasound image.

15. The image monitoring method of claim 13, wherein the at least one live body is a human body, and the status types comprise at least one of standing, sitting, lying, crawling and undefined.

16. The image monitoring method of claim 15, further comprising:
set the scene information of each pixel of the at least one status valid region to floor when the status type of the at least one live body is determined to be standing;
set the scene information of each pixel of the at least one status valid region to chair when the status type of the at least one live body is determined to be sitting; and
set the scene information of each pixel of the at least one status valid region to bed when the status type of the at least one live body is determined to be lying.

17. The image monitoring method of claim 13, wherein each pixel in the invisible light dynamic image has a probability distribution of the scene types, and the image monitoring method further comprises setting monitoring scene information of each pixel to the scene type having a highest probability in the probability distribution of the scene types of the pixel.

18. The image monitoring method of claim 17, further comprising: updating the probability distribution of the scene types of each pixel in the status valid region according to the least one status valid region of the at least one frame and the scene information of each pixel of the at least one status valid region.

19. The image monitoring method of claim 17, wherein the scene types comprise at least one of floor, bed, chair and an undefined type.

20. The image monitoring method of claim 13, wherein the scene types comprise at least one of floor, bed, chair and an undefined type.

21. The image monitoring method of claim 13, further comprising: storing the invisible light dynamic image and the scene type corresponding to each pixel in a memory.

22. The image monitoring method of claim 13, further comprising: performing operations according to another frame of the invisible light dynamic image to determine a status of a monitoring live body corresponding to the objective scene to be one of the status types and determine at least one detection valid region corresponding to the monitoring live body, determining whether the status of the monitoring live body is abnormal according to the at least one detection valid region corresponding to the monitoring live body, the status of the monitoring live body and the scene information of the at least one detection valid region corresponding to the monitoring live body, and outputting a warning signal when determining that the status of the monitoring live body is abnormal.

23. The image monitoring method of claim 17, further comprising: performing operations according to another frame of the invisible light dynamic image to determine a status of a monitoring live body in the objective scene to be one of the status types and determine at least one detection valid region corresponding to the monitoring live body, determining whether the status of the monitoring live body is abnormal according to the at least one detection valid region corresponding to the monitoring live body, the status of the monitoring live body and the monitoring scene information of the at least one detection valid region corresponding to the monitoring live body, and outputting a warning signal when determining that the status of the monitoring live body is abnormal.

24. The image monitoring method of claim 13, wherein the at least one live body is a plurality of live bodies, the at least one status valid region is a plurality of status valid regions, the live bodies respectively correspond to the status valid regions, and the image monitoring method comprises
performing operations according to the at least one frame of the invisible light dynamic image to determine each of statuses of the live bodies in the objective scene to be one of the status types and determine the status valid regions of the invisible light dynamic image; and
setting the scene information of each pixel of the corresponding status valid region to one of the scene types according to the status type of each of the live bodies.
